(19) United States
(12) Patent Application Publication
(10) Pub. No.: US 2025/0076326 A1
(43) Pub. Date: Mar. 6, 2025

(54) MICROPLATE TRANSFER APPARATUS AND MODULARIZED LIQUID-PHASE EQUIPMENT

(71) Applicant: SHIMADZU (CHINA) CO., LTD., Shanghai (CN)

(72) Inventors: Xiaojun XU, Shanghai (CN); Junshi GE, Shanghai (CN)

(21) Appl. No.: 18/821,628

(22) Filed: Aug. 30, 2024

(30) Foreign Application Priority Data
Sep. 1, 2023 (CN) 202322378980.6

(51) Int. Cl. G01N 35/00; G01N 35/10

(52) U.S. Cl. CPC G01N 35/00029; G01N 35/10; G01N 2035/00039

(57) ABSTRACT

The present disclosure provides a microplate transfer apparatus and a modularized liquid-phase equipment. The microplate transfer apparatus includes: a first frame extendable into the modularized liquid-phase equipment; a second frame connected to the first frame and fixed in place by being supported by the first frame in a state that the first frame extends into the modularized liquid-phase equipment; a chuck and a push-pull mechanism, the chuck and the push-pull mechanism being connected to the second frame, the chuck configured to be detachably connected to a microplate tray into which the microplate can be placed, the push-pull mechanism is configured to drive the chuck to push or pull the microplate tray to enter or exit the modularized liquid-phase equipment. The modularized liquid-phase equipment includes the microplate transfer apparatus and the microplate tray. The microplate transfer apparatus provided in the present disclosure can be added to the stacked modules of the modularized liquid-phase equipment conveniently, without occupying additional space and saving the need to change the original, compact position arrangement of the equipment in the laboratory.

### TECHNICAL FIELD

The present disclosure relates to the field of liquid chromatography and biopharmaceuticals, in particular to a microplate transfer apparatus for a modularized liquid-phase equipment and a modularized liquid-phase equipment.

### BACKGROUND

As shown in FIG. 1, existing modularized liquid-phase equipment has come into being very early, with high equipment completeness and large market maintenance. However, early design of the equipment only takes operations by human technicians into consideration and is not aware of the operations by an intelligent robot. As a result, the liquid supplement and liquid replacement processes cannot be included in a fully automatic smart intelligent inspection system covering the process from preparation through test result output of the modularized liquid-phase equipment. On the other hand, fully automatic inspection and intelligent laboratory are the current major research and development directions for detection instruments.

The cost would be high to automate existing modularized liquid-phase equipment (in particular the sample feeder) to be combined with intelligent robots. Therefore, it becomes urgent to rapidly include the equipment already put on the market in the intelligent system.

Patent literature CN115825456A for an invention discloses a UPLC (Ultra Performance Liquid Chromatography) analyzing equipment, which grasps a reagent sample to be tested by a mechanical arm secured on a platform, and then feeds the reagent sample into the analyzing equipment or picks up the reagent sample from the analyzing equipment. The mechanical arm that directly transfers the reagent sample into or away from the analyzing equipment requires high costs in use and maintenance and occupies a large space, and thus can be optimized.

### SUMMARY

In order to ameliorate or solve the problem proposed above, the present disclosure provides a microplate transfer apparatus and a modularized liquid-phase equipment.

The microplate transfer apparatus provided in embodiments of the present disclosure is used to transfer a microplate in a modularized liquid-phase equipment. The microplate transfer apparatus includes:
a first frame extendable into the modularized liquid-phase equipment;
a second frame connected to the first frame and fixed in place by being supported by the first frame in a state that the first frame extends into the modularized liquid-phase equipment;
a chuck and a push-pull mechanism, the chuck and the push-pull mechanism being connected to the second frame, the chuck configured to be detachably connected to a microplate tray into which the microplate can be placed, the push-pull mechanism is configured to drive the chuck to push or pull the microplate tray to enter or exit the modularized liquid-phase equipment, to transfer the microplate.

In at least one embodiment, the push-pull mechanism is a linearly movable mechanism arranged in the second frame, the chuck is connected to a movable member of the push-pull mechanism such that the chuck is movable in the push-pull mechanism along a straight-line advancing route.

In at least one embodiment, the second frame is provided with a support post that is liftable and lowerable, the support post in a lifted state supports the microplate tray.

In at least one embodiment, the second frame is provided with two or more of the support post arranged to be symmetrical with respect to an advancing route of the chuck, and the support post is disposed at an end of the second frame close to the modularized liquid-phase equipment.

In at least one embodiment, the chuck includes a first column and a second column, the microplate tray includes a push-pull slot, a slot wall on one side of the push-pull slot extends in-between the first column and the second column.

In at least one embodiment, a signal collection and transmission apparatus is integrated into the microplate transfer apparatus, when the chuck runs to a position of its operation track that is closest to a microplate attachment position in the modularized liquid-phase equipment, the signal collection and transmission apparatus is capable of acquiring a position signal of the chuck and transmits, to the modularized liquid-phase equipment, a signal of detecting a sample in the microplate; when the chuck runs to a position of its operation track that is farthest to the microplate attachment position in the modularized liquid-phase equipment, the signal collection and transmission apparatus is capable of acquiring a position signal of the chuck and transmits, to an external equipment, a signal of replacing the microplate.

In at least one embodiment, the first frame is configured to be attached below a sample feeder of the microplate transfer apparatus.

In at least one embodiment, the chuck and the push-pull mechanism drives the microplate tray to extend into or exit the sample feeder.

The modularized liquid-phase equipment provided in an embodiment of the present disclosure includes the afore-described microplate transfer apparatus and the microplate tray.

The modularized liquid-phase equipment provided in an embodiment of the present disclosure includes the afore-described microplate transfer apparatus and the microplate tray, wherein a loose plate is arranged in the push-pull slot, an interlock apparatus is arranged between the microplate tray and a microplate tray attachment position in the modularized liquid-phase equipment, the interlock apparatus is unlockable when the first column presses the loose plate towards the slot wall such as to enable the microplate tray to leave the microplate tray attachment position in the modularized liquid-phase equipment.

The microplate transfer apparatus provided in the present disclosure can be added to the stacked modules of the modularized liquid-phase equipment conveniently and is of good compatibility with the existing equipment. Compared to a solution of adding a mechanical arm on a lateral side of the modularized liquid-phase equipment, the frame structure of the present disclosure is extendable into the modularized liquid-phase equipment directly, without occupying additional space and saving the need to change the original, compact position arrangement of the equipment in the laboratory.

The modularized liquid-phase equipment of the present disclosure has the afore-described microplate transfer apparatus, and thus also attains to the above advantages.

### BRIEF DESCRIPTION OF THE DRAWINGS

FIG. 1 is a structural diagram of a modularized liquid-phase equipment.

FIG. 2 is a structural diagram of a microplate transfer apparatus according to an embodiment of the present disclosure.

FIGS. 3A, 3B, and 3C are respectively the front view, the top view, and the left view of the microplate transfer apparatus in an embodiment of the present disclosure when the chuck runs to a position of its operation track that is closest to the microplate attachment position in the modularized liquid-phase equipment.

FIGS. 4A, 4B, and 4C are respectively the front view, the top view, and the left view of the microplate transfer apparatus in an embodiment of the present disclosure when the chuck runs to a position of its operation track that is farthest to the microplate attachment position in the modularized liquid-phase equipment.

FIG. 5 is a front view of the modularized liquid-phase equipment according to an embodiment of the present disclosure.

FIG. 6 is a side view of the microplate transfer apparatus in an embodiment of the present disclosure when the chuck runs to a position of its operation track that is closest to the microplate attachment position in the modularized liquid-phase equipment.

FIG. 7 is a side view of the microplate transfer apparatus in an embodiment of the present disclosure when the chuck runs to a position of its operation track that is farthest to the microplate attachment position in the modularized liquid-phase equipment.

FIG. 8 is an amplified view of the structure at the connection between the chuck and the microplate tray of the modularized liquid-phase equipment according to an embodiment of the present disclosure.

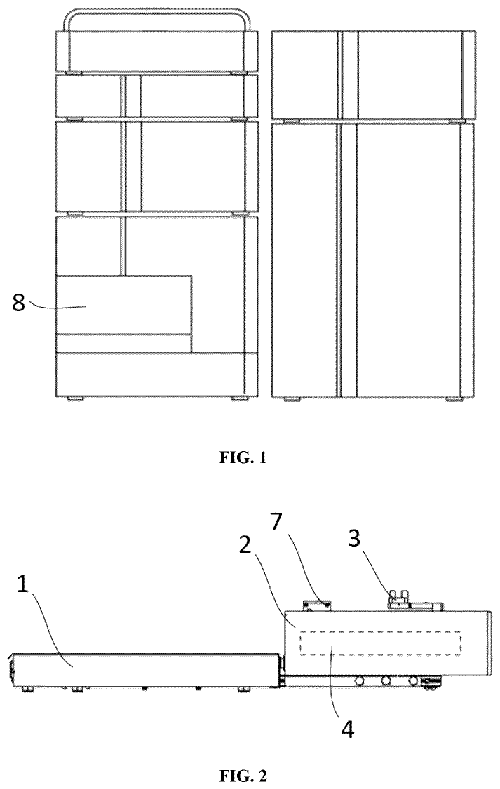

### REFERENCE SIGNS

1 first frame; 2 second frame; 3 chuck; 31 first column; 32 second column; 4 push-pull mechanism; 5 microplate tray; 51 push-pull slot; 52 slot wall; 53 loose plate; 6 microplate; 7 support post; 8 sample feeder.

### DETAILED DESCRIPTION

Exemplary embodiments of the present disclosure are described below with reference to the drawings. It is appreciated that these specific descriptions are merely an inspiration for those skilled in the art to implement the present disclosure. It is not intended to enumerate the implementations of the present disclosure in an exhaustive manner or to limit the present disclosure.

Referring to FIGS. 2, 5, and 7, an embodiment of the present disclosure provides a microplate transfer apparatus configured to transfer a microplate 6 in a modularized liquid-phase equipment. The microplate transfer apparatus may include a first frame 1, a second frame 2, a chuck 3, and a push-pull mechanism 4.

The first frame 1 is extendable into the modularized liquid-phase equipment. The second frame 2 is connected to the first frame 1. In a state that the first frame 1 extends into the modularized liquid-phase equipment, the second frame 2 is supported by the first frame 1 to be fixed in place. The chuck 3 and the push-pull mechanism 4 are connected to the second frame 2. The chuck 3 is configured to be detachably connected to a microplate tray 5. The microplate tray 5 is capable of holding the microplate 6. The push-pull mechanism 4 is configured to drive the chuck 3 to push or pull the microplate tray 5 to enter or exit the modularized liquid-phase equipment, to transfer the microplate 6.

It is appreciated that the microplate transfer apparatus provided in the present disclosure can be added to the stacked modules of the modularized liquid-phase equipment. Compared to a solution of adding a mechanical arm on a lateral side of the modularized liquid-phase equipment, the frame structure of the present disclosure is extendable into the modularized liquid-phase equipment directly, without occupying additional space and saving the need to change the original, compact position arrangement of the equipment in the laboratory. The weight of the second frame 2 may be borne by the first frame 1, saving the need to provide an additional weight-bearing floor or platform, which is more convenient.

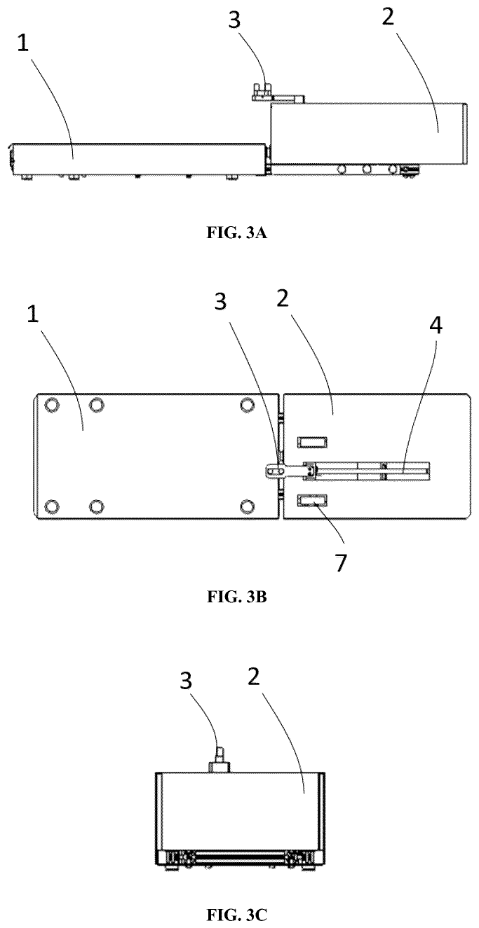

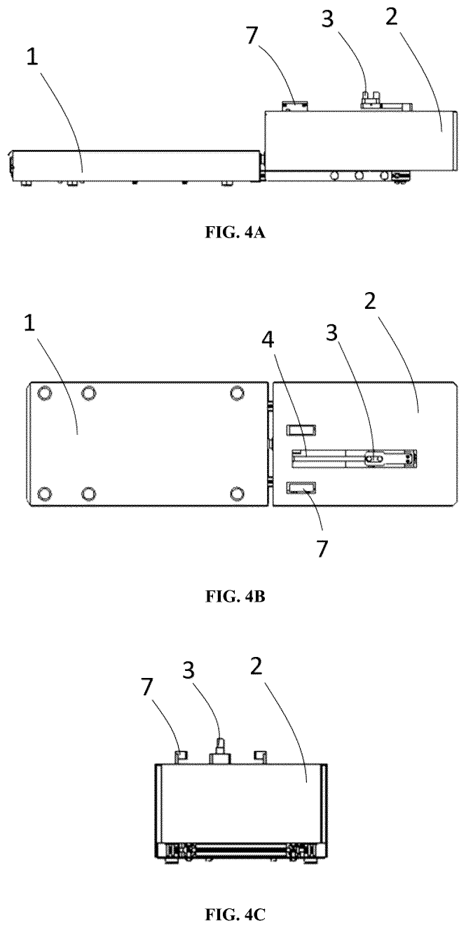

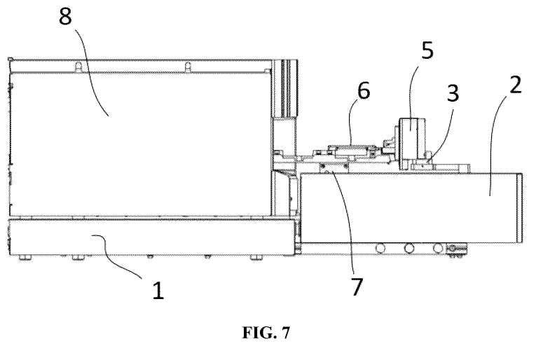

Referring to FIGS. 3A, 3B, 3C, and 6, these figures exemplarily show the respective locations of the components when the microplate tray 5 enters the modularized liquid-phase equipment. Referring to FIGS. 4A, 4B, 4C, and 7, these figures show the respective locations of the components when the microplate tray 5 is in a position farthest from the microplate attachment position in the modularized liquid-phase equipment.

Further, referring to FIGS. 3A to 4C, the push-pull mechanism 4 may be a linearly movable mechanism arranged in the second frame, such as a linear guide rail motor assembly, a ball screw assembly, etc. The chuck 3 is connected to the movable member of the push-pull mechanism 4 such that the chuck 3 is movable in the push-pull mechanism 4 along a straight-line advancing route.

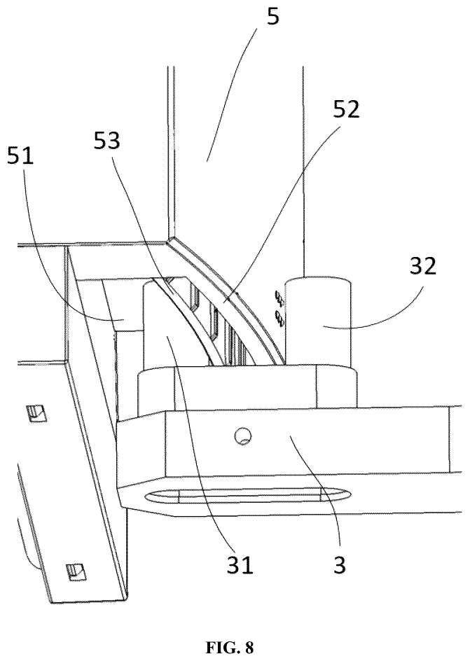

Further, referring to FIG. 8, the chuck 3 includes a first column 31 and a second column 32; the microplate tray 5 includes a push-pull slot 51. A slot wall 52 on one side of the push-pull slot 51 extends in-between the first column 31 and the second column 32 such that the chuck 3 is capable of driving the microplate tray 5 to move. It is appreciated that since the weight of the microplate tray 5 is borne by the rail structure of the modularized liquid-phase equipment when the microplate tray 5 enters and exits the modularized liquid-phase equipment, the chuck 3 does not necessarily bear the weight of the microplate tray 5 as long as the chuck 3 is capable of driving the microplate tray 5 to move. Of course, detachable connection between the chuck 3 and the microplate tray 5 is implementable in another manner.

Further, referring to FIGS. 3A to 4C, and 7, the second frame 2 may be provided with a liftable and lowerable support post 7. The support post 7 is configured to support the microplate tray 5 when the support post 7 is in a lifted state. The second frame 2 may be provided with two or more support posts 7 arranged to be symmetrical with respect to the advancing route of the chuck 3. Moreover, the support post 7 may be disposed at an end of the second frame 2 close to the modularized liquid-phase equipment. In an embodiment of the present disclosure, in particular upon picking up or placing a microplate 6, the two support posts 7 arranged symmetrically and the chuck 3 located at a distal end (see FIG. 4B) form a triangle so that the support post 7 functions as support and reinforcement. Thus the overall stability is improved and success rate of pick-up or placement of the microplate 6 increased.

Further, a signal collection and transmission apparatus is integrated into the microplate transfer apparatus. When the chuck 3 runs to a position of its operation track that is closest to the microplate attachment position in the modularized liquid-phase equipment (scc FIGS. 3A, 3B, 3C, and 6), the signal collection and transmission apparatus is capable of acquiring a position signal of the chuck 3 and transmits, to the modularized liquid-phase equipment, a signal of detecting a sample in the microplate 6. When the chuck 3 runs to a position of its operation track that is farthest to the microplate attachment position in the modularized liquid-phase equipment (see FIGS. 4A, 4B, 4C, and 7), the signal collection and transmission apparatus is capable of acquiring a position signal of the chuck 3 and transmits, to an external equipment, a signal of replacing the microplate 6. Of course, the signal collection and transmission apparatus is also capable of interaction with a signal from the modularized liquid-phase equipment or external equipment to execute corresponding operations.

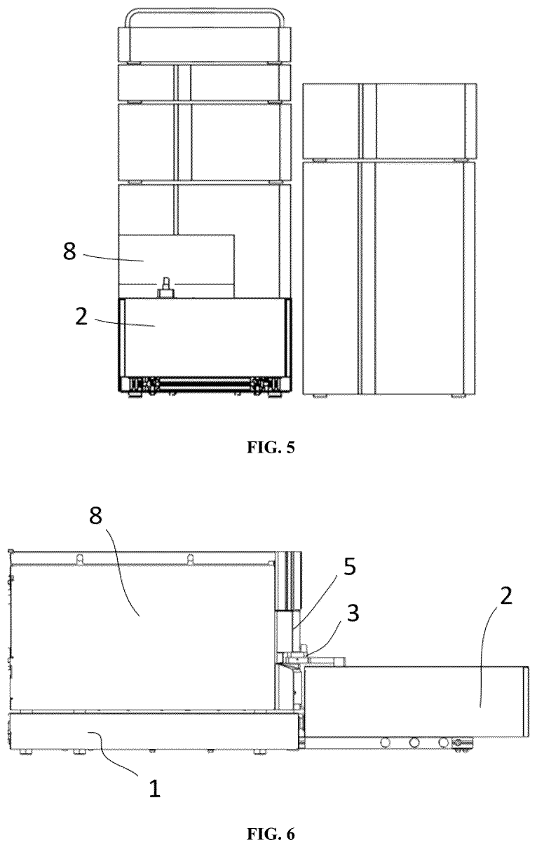

In an embodiment of the present disclosure, referring to FIGS. 5, 6, and 7, the first frame 1 is to be attached below a sample feeder 8 in the modularized liquid-phase equipment. The chuck 3 and push-pull mechanism 4 in the second frame 2 drive the microplate tray 5 to enter or exit the corresponding structure of the sample feeder 8.

An exemplary operation process of the microplate transfer apparatus provided in present disclosure is described subsequently.
(1) The first frame 1 of the microplate transfer apparatus is stacked below the sample feeder 8, and the chuck 3 clasps the microplate tray 5;
(2) The push-pull mechanism 4 is activated to move the chuck 3 as well as the microplate tray 5 outwardly;
(3) The chuck 3 runs to the position of its operation track that is farthest to the microplate attachment position in the modularized liquid-phase equipment (see FIGS. 4A, 4B, 4C, and 7, the position also referred to as an open position of the microplate tray 5), where the support post 7 is lifted to abut against the microplate tray 5 from below; the support post 7 provides support for the microplate tray 5 when the microplate 6 is placed;
(4) The microplate 6 containing the sample to be tested is placed onto the microplate tray 5 by means of a robot or the like;
(5) When the microplate 6 has been placed, the push-pull mechanism 4 is activated to cause the chuck 3 as well as the microplate tray 5 to move inwardly till the chuck 3 runs to the position of its operation track that is closest to the microplate attachment position in the modularized liquid-phase equipment (see FIGS. 3A, 3B, 3C, and 6, the position also referred to as a close position of the microplate tray 5);
(6) The microplate transfer apparatus transmits, to the sample feeder 8 in the modularized liquid-phase equipment, a signal indicating that operation is enabled, and the sample feeder 8 starts to test the sample; upon completion of sample test, the sample feeder 8 transmits a signal to the microplate transfer apparatus to allow the microplate tray 5 to retreat to its open position;
(7) The microplate transfer apparatus drives the microplate tray 5 to move to the open position; upon detecting that the chuck 3 runs to a position of its operation track that is farthest to the microplate attachment position in the modularized liquid-phase equipment (i.e., the microplate tray 5 is in the open position), the signal collection and transmission apparatus of the microplate transfer apparatus transmits a signal to an existing external equipment (robot, etc.) to pick up the microplate 6 of which the sample has been tested and place a new microplate 6 that has not been tested and start a new round of test.

The microplate transfer apparatus provided in the present disclosure can be added to the stacked modules of the modularized liquid-phase equipment conveniently and is of good compatibility with the existing equipment. By avoiding internal reconstruction of the existing equipment and providing an additional external mechanism instead, it is possible to conveniently realize automatically pick-up and placement of microplates from and in the existing modularized liquid-phase equipment (in particular the sample feeder 8). In automation of a laboratory, it is possible for an equipment provider to save the cost for research and development of a new model of the sample feeder 8, and it is possible for the client to save the cost for purchasing new equipment.

The modularized liquid-phase equipment provided in the present disclosure may include the afore-described microplate transfer apparatus and the microplate tray 5.

Further, referring to FIG. 8, a loose plate 53 is arranged in the push-pull slot 51 of the microplate tray 5, and an interlock apparatus is arranged between the microplate tray 5 and a microplate tray attachment position in the modularized liquid-phase equipment. The interlock apparatus is unlockable when the first column 31 presses the loose plate 53 towards the slot wall 52 such as to enable the microplate tray 5 to leave the microplate tray attachment position in the modularized liquid-phase equipment. The interlock apparatus is capable of preventing the microplate tray 5 from slipping off accidentally, thereby improving safety. A resilient member such as a spring may be provided between the loose plate 53 and the slot wall 52. When the chuck 3 pulls the microplate tray 5, the first column 31 of the chuck 3 presses the loose plate 53 to unlock the interlock apparatus. Of course, after the chuck 3 moves to the position of its operation track that is farthest to the microplate attachment position in the modularized liquid-phase equipment, the resilient force generated between the loose plate 53 and the slot wall 52 may cause the microplate tray 5 to continue to move along a short path, thereby controlling the chuck 3 to cause the microplate tray 5 to retreat over a small distance, which offsets an error in the moving distance caused by the loose plate 53, so that the position of the microplate tray 5 is more accurate.

Described in the foregoing are preferable embodiments of the present disclosure. Note that a number of improvements and modifications may occur to those skilled in the art without departing from the principle of the present disclosure, and such improvements and modifications should be considered encompassed in the scope of the present disclosure.

What is claimed is:

1. A microplate transfer apparatus for transferring a microplate (6) in a modularized liquid-phase equipment, the microplate transfer apparatus comprising:
a first frame (1) extendable into the modularized liquid-phase equipment;
a second frame (2) connected to the first frame (1) and fixed in place by being supported by the first frame (1) in a state that the first frame (1) extends into the modularized liquid-phase equipment;
a chuck (3) and a push-pull mechanism (4), the chuck (3) and the push-pull mechanism (4) being connected to the second frame (2), the chuck (3) configured to be detachably connected to a microplate tray (5) into which the microplate (6) can be placed, the push-pull mechanism (4) is configured to drive the chuck (3) to push or pull the microplate tray (5) to enter or exit the modularized liquid-phase equipment, to transfer the microplate (6).

2. The microplate transfer apparatus according to claim 1, wherein the push-pull mechanism (4) is a linearly movable mechanism arranged in the second frame (2), the chuck (3) is connected to a movable member of the push-pull mechanism (4) such that the chuck (3) is movable in the push-pull mechanism (4) along a straight-line advancing route.

3. The microplate transfer apparatus according to claim 1, wherein the second frame (2) is provided with a support post (7) that is liftable and lowerable, the support post (7) in a lifted state supports the microplate tray (5).

4. The microplate transfer apparatus according to claim 3, wherein the second frame (2) is provided with two or more of the support post (7) arranged to be symmetrical with respect to an advancing route of the chuck (3), and the support post (7) is disposed at an end of the second frame (2) close to the modularized liquid-phase equipment.

5. The microplate transfer apparatus according to claim 1, wherein the chuck (3) comprises a first column (31) and a second column (32), the microplate tray (5) comprises a push-pull slot (51), a slot wall (52) on one side of the push-pull slot (51) extends in-between the first column (31) and the second column (32).

6. The microplate transfer apparatus according to claim 1, wherein a signal collection and transmission apparatus is integrated into the microplate transfer apparatus, when the chuck (3) runs to a position of its operation track that is closest to a microplate attachment position in the modularized liquid-phase equipment, the signal collection and transmission apparatus is capable of acquiring a position signal of the chuck (3) and transmits, to the modularized liquid-phase equipment, a signal of detecting a sample in the microplate (6); when the chuck (3) runs to a position of its operation track that is farthest to the microplate attachment position in the modularized liquid-phase equipment, the signal collection and transmission apparatus is capable of acquiring a position signal of the chuck (3) and transmits, to an external equipment, a signal of replacing the microplate (6).

7. The microplate transfer apparatus according to claim 1, wherein the first frame (1) is configured to be attached below a sample feeder (8) of the microplate transfer apparatus.

8. The microplate transfer apparatus according to claim 7, wherein the chuck (3) and the push-pull mechanism (4) drives the microplate tray (5) to extend into or exit the sample feeder (8).

9. A modularized liquid-phase equipment, comprising the microplate transfer apparatus of claim 1 and the microplate tray (5).

10. A modularized liquid-phase equipment, comprising the microplate transfer apparatus according to claim 5 and the microplate tray (5), wherein a loose plate (53) is arranged in the push-pull slot (51), an interlock apparatus is arranged between the microplate tray (5) and a microplate tray attachment position in the modularized liquid-phase equipment, the interlock apparatus is unlockable when the first column (31) presses the loose plate (53) towards the slot wall (52) such as to enable the microplate tray (5) to leave the microplate tray attachment position in the modularized liquid-phase equipment.
